(19) United States
(12) Patent Application Publication
(10) Pub. No.: US 2010/0245940 A1
(43) Pub. Date: Sep. 30, 2010

(54) U-SHAPE OPTICAL PATH IMAGE SCANNING METHOD AND SCANNING MODULE THEREOF

(75) Inventors: AI-LIEN LAI, Taipei (TW); CHING-YUAN LIN, Taipei (TW); SAN-WOEI SHYU, Taipei (TW)

Correspondence Address: Wang Law Firm, Inc., 4989 Peachtree Parkway,, Suite 200, Norcross, GA, 30092, US

(73) Assignee: E-PIN OPTICAL INDUSTRY CO., LTD., Taipei (TW)

(21) Appl. No.: 12/635,198

(22) Filed: Dec. 10, 2009

(30) Foreign Application Priority Data
Mar. 31, 2009 (TW) 098110763

(51) Int. Cl. H04N 1/04

(52) U.S. Cl. 358/474

(57) ABSTRACT

The present invention discloses a U-shape optical path image scanning method and a scanning module thereof, in which an image of a document is reflected by a plurality of reflection mirrors to form image beams, and the image beams which enter the scanning module and the image beams which enter the pickup lens form a U-shape optical path. Optical axis of the pickup lens and the scanning module are parallel to the image of the document so as to prevent scattered beams from entering the pickup lens or forming a ghost image. Accordingly, the depth of field not only can be increased by increasing the length of the optical path in a limited space, but the pickup lens and the image sensor also can be easily adjusted in manufacture or assembly to reduce the assembly complexity and improve the mass production rate.

### BACKGROUND OF THE INVENTION

1. Field of the Invention

The present invention relates to a U-shape optical path image scanning method and a scanning module thereof, in particular to a U-shape optical path image scanning module applied for a flatbed seamier or a multi-function printer.

2. Description of the Related Art

In recent years, scanner, particularly image scanner, becomes a major computer peripheral product, and the image scanner can capture an image of an object such as a document, a textual page, a photo, a film or even a flat object. The image can be captured by a way of projecting a light onto the document first, such that the light reflected by the document forms an image beam, and then using a plurality of reflection mirrors to reflect and change its optical path, such that the light is focused at an image sensor by a pickup lens. Since the content of the document is generally composed of texts or graphics, therefore the light absorption rate is relatively high, if a portion of light is projected onto a textual area or a graphic area, and the light absorption rate is relatively low, if a portion of light is projected onto a non-textual area or a non-graphic area. As a result, areas with different brightness will be formed. Therefore, the reflected image beams have different intensity areas respective to the positions of the document. Then, an image sensor (such as charge-coupled device, CCD) converts the focused image beam into a photo-electric signal, and then the photo-electric signal was read by a scanning software program, and finally a digital image is formed. The image of document can be stored in a file format of TIFF, EPS, BMP, GIF and PCX, etc. A commercial scanner such as a flat-bed scanner is used for scanning photos or printed matters. The scanner includes a cover glass disposed thereon for placing a desired document to be scanned, and a scanning module is moved by a rail to scan the document sequentially column by column, and convert the images into digital data, and the aforementioned operating principle is adopted generally by scanners. Related equipments of a scanner manufactured by a similar principle such as multi-function printers scan an image by moving the document with respect to the scanning module.

With reference to FIGS. 1 to 3, schematic views of structures and optical path arrangements of different conventional scanning modules respectively are shown. The scanning module 91 includes a cover glass 12, a frame 13, an image sensor 14, a pickup lens 15, a light source 16 and reflection mirrors 917. The light source 16 emits a light to be projected onto a document 2 to be scanned to form an image beam, and different ways of arranging the reflection minors 917 are adopted for changing the direction and path of the image beam, such that the image beam is incident into the pickup lens 15 and the image sensor 14, and the length of the path of the image beam is called an optical distance. In a limited space of the scanning module 91, the longer the optical distance, the higher is the depth of field as to the pickup lenses 15 and image sensors 14 of the same resolution, and also the better is the image as to wrinkles document 2. An image beam gone through the reflection process for several times, the image beam is affected by the width of the beam, such that the angle of reflection of lights on both sides of the image beam is deviated from a predetermined traveling direction to produce a scattered light. After the scattered light is projected at the pickup lens 15, the scattered lights may form a ghost image. To overcome the aforementioned problem, different solutions are disclosed in U.S. Pat. No. 6,058,281, U.S. Pat. No. 6,227,449, US2008/0007810, US2008/0170268, U.S. Pat. No. 6,421,158, and U.S. Pat. No. 5,815,329; Japan Patent Nos. JP60-06524, JP2005-328187, JP2004-274299; Great Britain Patent No. GB2317293; and R.O.C. Pat. Nos. TW418367 and TW476-494. In FIG. 1, four reflection mirrors 917 are used, and each reflection mirror 917 reflects an image beam once. In FIG. 2, five reflection minors 917 are used, and one of the reflection mirrors 917 reflects an image beam twice. In FIG. 3, the reflection mirrors 917 are arranged on forward side of the document 2, and the pickup lens 15 and the image sensor 14 are moved or the light source 16 is moved to perform a scan.

In addition to the requirements of a better depth of field and an elimination of a ghost image phenomenon, the optical axis of the pickup lens 15 and the image sensor 14 of the conventional scanning module is substantially perpendicular to the incident image beam of the scanning module 91. Therefore, when the scanning module 91 is disposed, the image sensor 14 fixed onto the frame 13 must be moved on the X-Y plane for a calibration, and adjusted to a precisely aligned position. In the calibration process, the image sensor 14 is placed vertically, such that when the image sensor 14 is moved on the X-Y plane, a deviation in the Z direction will be produced due to the weight of the image sensor 14. To overcome this problem, the prior arts used complicated precision fixtures to perform a calibration in X, Y and Z directions synchronously, and thus increasing the calibration time and the level of difficulty for mass productions.

### SUMMARY OF THE INVENTION

Therefore, it is an objective of the present invention to overcome the aforementioned shortcomings of the prior art by providing a U-shape optical path image scanning method to increase the depth of field and eliminate the ghost image phenomenon.

To achieve the foregoing objectives, the present invention provides a U-shape optical path image scanning method in which an image of a document to be scanned is reflected by a plurality of reflection mirrors to change the direction and path of the reflection and increase an optical path such that the image beams which enter the scanning module and the image beams which enter the pickup lens form a U-shape optical path, and then an image sensor converts the image beams into photo-electric signals. As shown in FIG. 4, the method comprises the following steps:

S1: A light emitted from a light source is incident to a document to be scanned, and the document to be scanned reflects the light to form an image beam Lᵢ incident into a scanning module. The image beam Li leads in a +Z-axis direction, i.e., an included angle between the direction of \vec{L}ᵢ and the +Z-axis is 0 on the X-Z plane, and

$$1 = \frac{{\vec{L}}_{i} \cdot \vec{k}}{\vert {\vec{L}}_{i} \vert} \qquad ( 1 )$$

where \vec{k} is a unit vector in the +Z-axis direction, |\vec{L}ᵢ| is the length of the image beam Lᵢ, as shown in FIG. 6.

S2: At least two reflection mirrors are disposed, which reflect the image beam Lᵢ to form an image beam Lₒ incident to the pickup lens, and then an included angle φ between the image beam Lₒ and the image beam Lᵢ on the X-Z plane is adjusted to satisfy the condition of:

$$- 1 \leq cos ( π - φ ) = \frac{{\vec{L}}_{o} \cdot \vec{k}}{\vert {\overline{L}}_{o} \vert} \leq - 0.707 \qquad ( 2 )$$

where φ is an included angle between the image beam Lo and an axial line parallel to the Z-axis, \vec{k} is a unit vector in the +Z-axis direction, and |\vec{L}ₒ| is the length of the image beam Lₒ, as shown in FIG. 6.

S3: The optical axis of the pickup lens and the image sensor are calibrated such that the optical axis of the pickup lens and the image sensor are coincide with the image beam Lₒ incident to the pickup lens.

According to the U-shape optical path image scanning method provided by the present invention, at least two reflection mirrors are used to reflect the image beam Lᵢ, so as to increase the length of the optical path and the depth of field of the image beam Lₒ. Moreover, the image beam Lₒ incident to the pickup lens and the image beam Lᵢ incident to the scanning module are in opposite directions, and therefore, scattered lights produced by the multiple reflections of the image beams from the reflection mirrors will not enter the field of angle of the pickup lens, and thus the ghost image phenomenon can be eliminated to enhance the scanned image quality.

With reference to FIG. 11, a scanning module applicable for the U-shape optical path image scanning method in accordance with the present invention is shown. The scanning module comprises at least one light source, a plurality of reflection mirrors, a pickup lens, an image sensor and a frame. The angular relationship between the reflection mirrors satisfies the condition of:

$$- \frac{π}{4} \leq {\sum }_{i = 1}^{n} {α}_{i} - \frac{π}{2} ( n + 1 ) \leq \frac{π}{4} \qquad ( 3 )$$

where αᵢ is an included angle formed by the normal line of a reflecting surface of the i^{th} reflection mirror and the +Z-axis along the optical path, whose symbols are illustrated in FIG. 5, αᵢ is an included angle formed by the normal line 31 of the reflection mirror M1 and the +Z-axis (or +k direction), α₂ is an included angle formed by the normal line 32 of the reflection mirror M2 and the +Z-axis (or +k direction), and u is the total number of reflecting times along the optical path, such as n=9 as shown in FIG. 11:

$${\sum }_{i = 1}^{n} {α}_{i} - \frac{π}{2} ( n + 1 ) = ( \begin{matrix}{α}_{1} + {α}_{2} + {α}_{3} + {α}_{4} + {α}_{3} + \\ {α}_{4} + {α}_{3} + {α}_{2} + {α}_{5}\end{matrix} ) - \frac{π}{2} ( 9 + 1 )$$

In the scanning module applicable for the U-shape optical path image scanning method of the present invention, wherein the axial direction of an optical axis of a pickup lens is opposite to the direction of the image beam Lᵢ incident to the scanning module, and whose optical path is a U-shape and satisfies the aforementioned conditions of Equation (2).

To reduce the scattered lights from entering the pickup lens, it is preferably to have an included angles θ of the optical axis of the pickup lens and the image sensor and a line parallel to the image beam Lᵢ satisfy the condition of:

$$θ \leq {{tan}^{- 1} ( \frac{λ}{{D}_{o}} )}^{2} \qquad ( 4 )$$

where, 2λ is a diagonal length of an effective sensing range of the image sensor, and Dₒ is the distance from the last reflecting point to the surface of image sensor along the optical axis, as shown in FIG. 7.

If alternative components are used or one light source or two (or more) light sources are used, it will be not necessary to change the position and angle of the reflection mirrors. Users simply need to calibrate the image beam to be incident to the scanning module to a predetermined position. Once if a pickup lens with a different focal length is used, 2, 3, 4, 5 (or more) reflection mirrors can be suitably used to provide a different total length (TTL) of the optical path to give a different depth of field. Once if an image sensor of a different size is replaced to change the position of the image beam Lₒ, users simply need to adjust the reflecting position of the image beam Lₒ. Further, the position of the pickup lens can be adjusted to fit a pickup lens with a different focal length in order to provide a broader scope of applications.

Therefore, a U-shape optical path image scanning method and a scanning module thereof in accordance with the present invention have one or more of the following features:

(1) The reflection mirrors reflect the image beam to increase the depth of field. Since the image beam forms a U-shape optical path in its traveling process, the scattered lights produced by the multiple reflections from the reflection mirrors can be reduced or eliminated to effectively prevent the ghost image phenomenon.

(2) During manufacture or assembly, the optical axis of the pickup lens and the image sensor can be adjusted easily to coincide with the optical axis of the image beam Lₒ, so as to reduce the assembly difficulty and enhance the mass production rate.

(3) One light source, or two (or more) light sources, and 2, 3, 4, 5 (or more) reflection mirrors can be adopted in the U-shape optical path scanning module to produce a different depth of field. Further, the position of the pickup lens can be adjusted to fit a pickup lens of a different focal length, so as to provide a broader scope of applications.

### BRIEF DESCRIPTION OF THE DRAWINGS

FIG. 1 is a schematic view of a first conventional scanning module;

FIG. 2 is a schematic view of a second conventional scanning module;

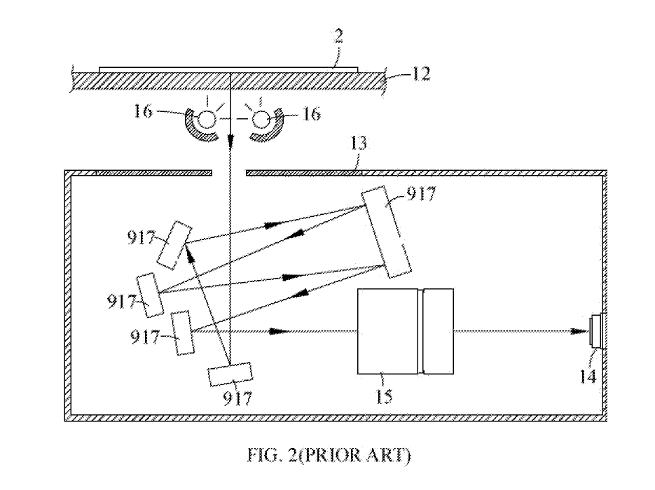

FIG. 3 is a schematic view of a third conventional scanning module;

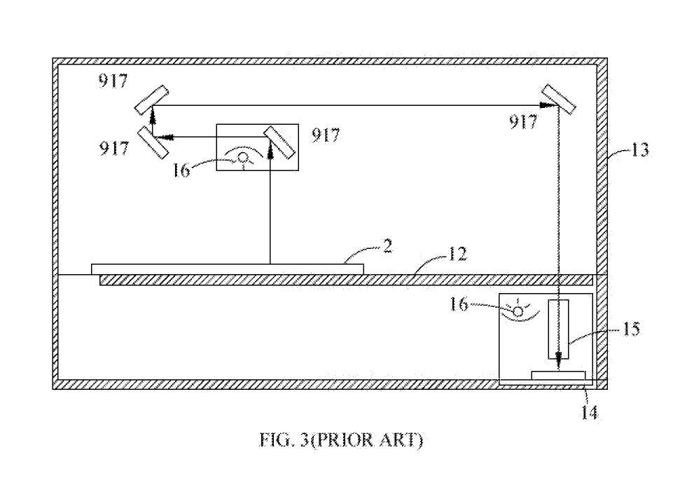

FIG. 4 is a flow chart of a U-shape optical path image scanning method in accordance with the present invention;

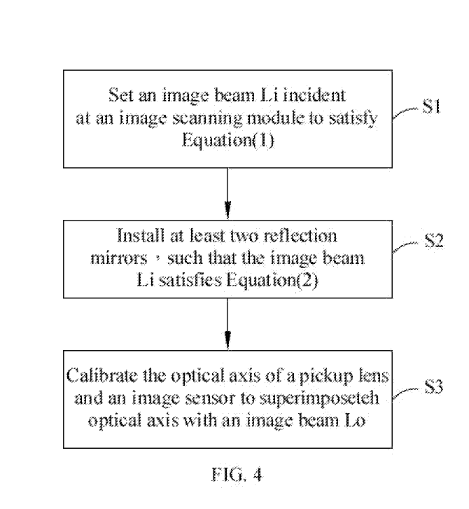

FIG. 5 shows symbols for illustrating an included angle between the normal line of a reflecting surface of a reflection minor and the Z-axis along an optical path;

FIG. 6 is a schematic view of an included angle formed by optical axis of a pickup lens and an axial line parallel to the Z-axis;

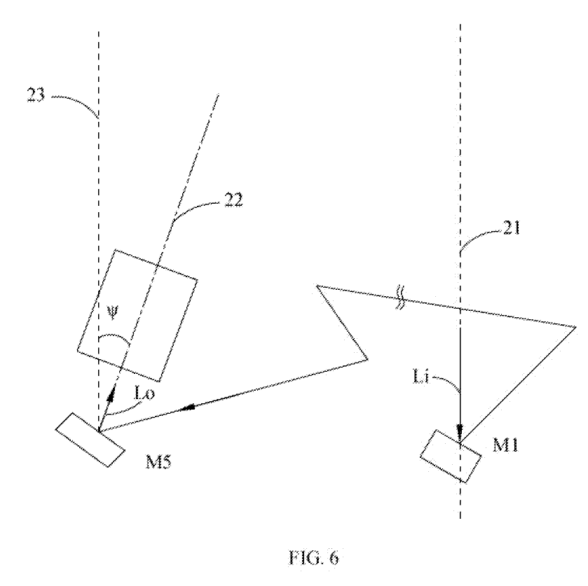

FIG. 7 is a schematic view of an included angle formed by an image beam Lo and an axial line parallel to the Z-axis;

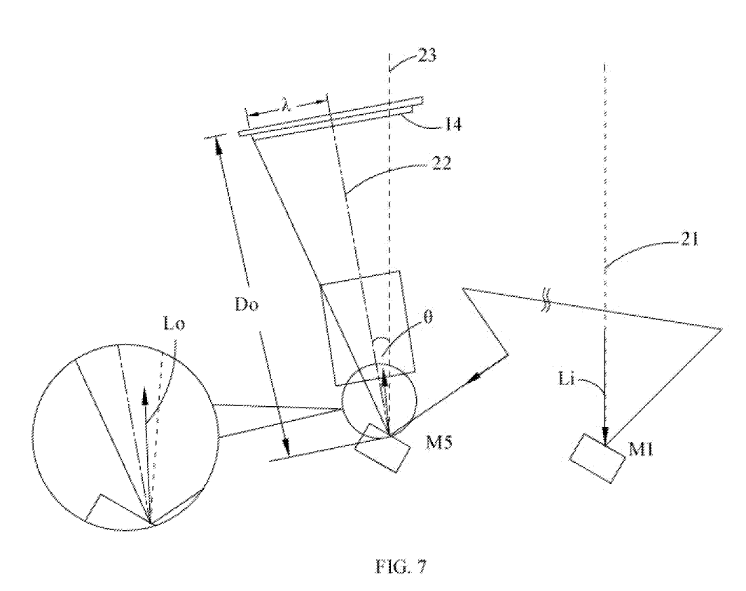

FIG. 8 is a schematic view of a scanning module in accordance with a first preferred embodiment of the present invention;

FIG. 9 is a schematic view of a scanning module in accordance with a second preferred embodiment of the present invention;

FIG. 10 is a schematic view of a scanning module in accordance with a third preferred embodiment of the present invention; and

FIG. 11 is a schematic view of a scanning module in accordance with a fourth preferred embodiment of the present invention.

### DETAILED DESCRIPTION OF THE PREFERRED EMBODIMENTS

The present invention will now be described in more detail hereinafter with reference to the accompanying drawings that show various embodiments of the invention as follows.

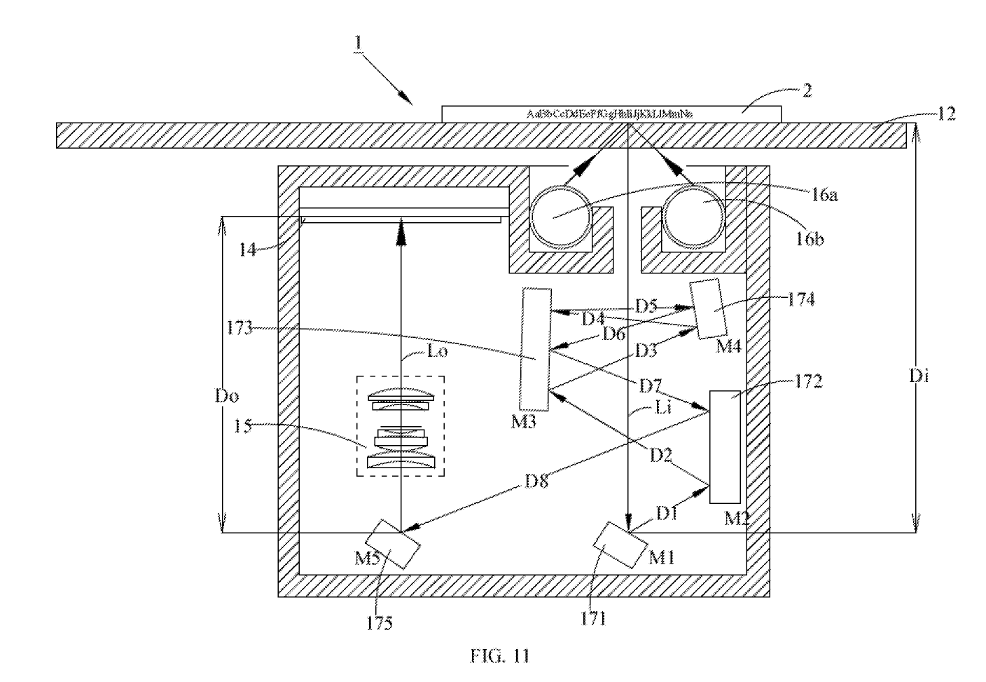

With reference to FIG. 11, a schematic view of a scanning module in accordance with a preferred embodiment of the present invention is shown. The scanning module 1 comprises two light sources 16a, 16b, five reflection mirrors (M1, M2, M3, M4, M5) 171˜175, a pickup lens 15, an image sensor 14 and a frame 13. The light source 16 emits a light that passes through a cover glass 12 and is projected onto a document 2 to be scanned. The light reflected from the document 2 to be scanned passes through the cover glass 12 to form an image beam Lᵢ 21 incident to the scanning module 1. The image beam Lᵢ 21 is reflected sequentially from a first reflection mirror (M1) 171 for the first-time reflection, a second reflection mirror (M2) 172 for the second-time reflection, a third reflection mirror (M3) 173 for the third-time reflection, a fourth reflection mirror (M4) 174 for the fourth-time reflection, the third reflection mirror (M3) 173 for the fifth-time reflection, the fourth reflection minor (M4) 174 of the sixth-time reflection, the third reflection minor (M3) 173 for the seventh-time reflection, the second reflection mirror (M2) 172 for the eighth-time reflection, a fifth reflection mirror (M5) 175 for the ninth-time reflection to finally form an image beam Lₒ incident to the pickup lens 15. For simplicity, the optical path can be represented by Lᵢ→M1→M2→M3→M4→M3→M4→M3→M2→M5→Lₒ, and the travelling directions of the image beam Lᵢ and the image beam Lₒ are opposite to each other, and substantially form a U-shape optical path.

The angular relationship of each reflection minor satisfies the condition of:

$$- \frac{π}{4} \leq {\sum }_{i = 1}^{n} {α}_{i} - \frac{π}{2} ( n + 1 ) \leq \frac{π}{4}$$

On the X-Z plane, the travelling direction of the image beam Lₒ 22 is opposite to the +Z-axis, and an included angle θ formed by the image beam Lₒ and the axial line 23 parallel to the Z-axis satisfies the condition of:

$$- 1 \leq cos ( π - φ ) = \frac{{\vec{L}}_{o} \cdot \vec{k}}{\vert {\vec{L}}_{o} \vert} \leq - 0.707$$

When the scanning module 1 is assembled, the included angle θ formed by the optical axis of the pickup lens 15 and the image sensor 14 and the axial line parallel to image beam Lᵢ (i.e. parallel to the +Z-axis) satisfy the condition of

$$θ \leq {{tan}^{- 1} ( \frac{λ}{{D}_{o}} )}^{2}$$

The position relationship between the reflection minors is determined by the coordinates (M_{iX}, M_{iZ}) of a reflecting point which represents the position of the i^{th} reflection minor in the X-Z plane, the angle of the reflection mirror and the angle of the light incident to the reflection mirror:

M_{(i+1)X}=M_{iX}−Dᵢ sin(180±2αᵢ₁+βᵢ)

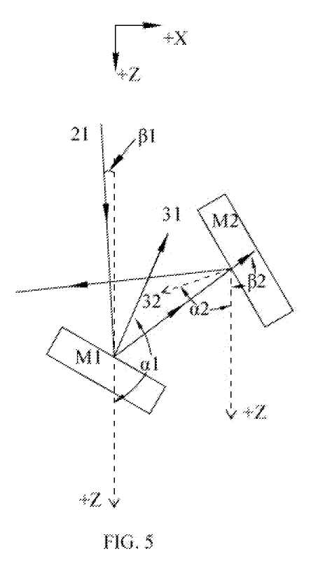

M_{(i+1)Z}=M_{iZ}−Dᵢ cos(180±2αᵢ₁+βᵢ) (5)

where αᵢ is an included angle between the normal line of a reflecting surface of the i^{th} reflection mirror and the +Z-axis along the optical path, (M_{iX}, M_{iZ}) is the (X, Z) coordinates of a reflecting point of the i^{th} reflection mirror, and βᵢ is an included angle between the image beam incident to the i^{th} reflection minor and the +Z-axis, as shown in FIG. 5.

The image beam is reflected by the reflection minor (M2) 172 for two times, by the reflection mirror (M3) 173 for three times, and by the reflection mirror (M4) 174 for two times. In the prior art, intensely scattered lights are produced in multiple reflections, and a ghost image is formed. It is necessary to adjust the width or angle of the reflection mirror appropriately to reduce the scattered lights. However, the scanning module 1 of this preferred embodiment adopts a U-shape optical path image scanning method, and uses less reflection mirrors for performing the multiple reflections, so as to increase the length of the optical path and the depth of field. In addition, the U-shape optical path is formed by the light beam, such that the pickup lens 15 is aligned in a direction opposite to the direction of the incident image beam Lᵢ, and the image capturing angle of the pickup lens 15 is controlled to prevent the scattered lights reflected back and forth among the reflection mirrors. Therefore, a vast majority of scattered lights is absorbed completely by an internal wall of the frame 13 to substantially reduce or eliminate the scattered fights, so as to prevent the ghost image phenomenon effectively.

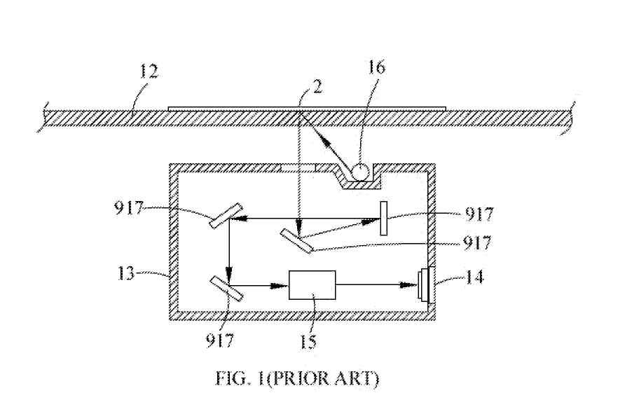

During the manufacturing and assembling processes of the scanning module 1, the image sensor 14 is disposed horizontally (on the X-Y plane), and thus the image sensor 14 can be retained onto the frame 13 directly, such that when the optical axis is calibrated and closing to with the image beam Lo, users simply need to calibrate the X-Y direction only. Such arrangement can improve the prior art as shown in FIG. 1, wherein the image sensor 14 of the prior art is disposed vertically, and thus it is difficult to make the calibration in the Y-Z direction due to the gravitational force of the image sensor 14. Obviously, the invention can reduce the level of difficulty of the assembling and improve the mass production rate.

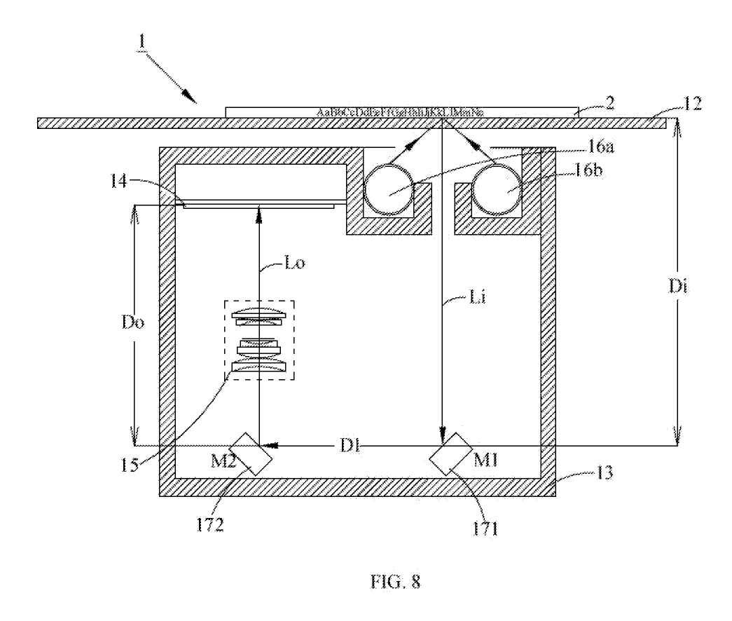

In a first preferred embodiment, a scanning module with two reflection mirrors is adopted. With reference to FIG. 8, a schematic view of a scanning module 1 using two reflection minors in accordance with a first preferred embodiment of the present invention is shown. The scanning module 1 comprises two cold cathode fluorescent lamp light sources 16a, 16b, two reflection mirrors M1 (171), M2 (172), a pickup lens 15, an image sensor 14 and a frame 13.

The light sources 16a, 16b emit lights that pass through a cover glass 12 and are projected onto the document 2 to be scanned to produce an image beam Lᵢ incident to the scanning module 1. The image beam Lᵢ is reflected by the reflection mirror M1 and projected onto the reflection mirror M2, the reflection mirror M2 reflects the image beam to form an image beam Lₒ, and then the pickup lens 15 focuses the image beam Lₒ to form an image at the surface of image sensor 14. The frame 13 is provided for containing each component in the scanning module 1, and the optical path is Obj→M1→M2→Img, and the total optical path length (TTL) is Di+D₁+Do=164.85 mm. An included angle between the normal line of a reflecting surface of the reflection mirror M1 (171), M2 (172) and the +Z-axis is αᵢ, and the coordinates of a reflecting point of the reflection mirror M1 (171), M2 (172) are (M_{iX}, M_{iZ}), as shown in Table 1:

TABLE 1
Optical Parameters of the First Preferred Embodiment

| Surface | αᵢ (°deg.) | Dᵢ (mm) | (M_{iX}, M_{iZ}) |
|---|---|---|---|
| Obj | | 0 | (0, 0) |
| M1 | 135.00 | 71.84 | (0, 71.84) |
| M2 | 135.00 | 40.38 | (−40.38, 71.84) |
| Img | | 52.65 | (−41.31, 19.20) |

Since the traveling directions of the image beam Lᵢ incident to the scanning module 1 and the image beam Lₒ incident to the pickup lens 15 are opposite to each other; and the optical path is in a U-shape, and the pickup lens 15 is aligned towards the −Z-axis direction, therefore the scattered light of the image beam Lᵢ can be reduced, and the scattered light of the image beam reflected from the reflection minor M1 entering into the pickup lens 15 can be reduced to eliminate the ghost image phenomenon effectively.

On the X-Z plane, \vec{L}ₒ=(−0.937\vec{i}−52.64\vec{k}), and φ=1.012 (deg.) satisfy the condition of:

$$- 1 \leq \frac{{\vec{L}}_{o} \cdot \vec{k}}{\vert {\vec{L}}_{o} \vert} = - 0.99984 \leq - 0.707$$

where an included angle θ is an included angle between the image beam Lₒ and an axial line parallel to the Z-axis, |\vec{L}ₒ| is the length of the image beam Lo, and \vec{k} is a unit vector in the +Z-axis direction.

The angles of the reflection mirror M1 (171) and the reflection mirror M2 (172) and

$${\sum }_{i = 1}^{2} {α}_{i} - \frac{π}{2} ( 2 + 1 ) = 0$$

satisfy the condition of:

$$- \frac{π}{4} \leq {\sum }_{i = 1}^{2} {α}_{i} - \frac{π}{2} ( 2 + 1 ) = 0 \leq \frac{π}{4} ;$$

where αᵢ is an included angle between the normal line of a reflecting surface of the i^{th} reflection minor in the optical path and the +Z-axis, and u is the total number of reflecting times along the optical path, and n=2 in this preferred embodiment.

The image sensor 14 used in this preferred embodiment is 1.58×35.02 mm, 2λ=35.05 mm, and tan

$${{tan}^{- 1} ( \frac{λ}{{D}_{o}} )}^{2} = 6.327 ( deg . ) .$$

In this preferred embodiment, the included angle θ between the optical axis of the pickup lens 15 and the image sensor 14 and the axial line parallel to the Z-axis is equal to 0.127°, and satisfies the condition of

$$θ = 0.127 ° \leq {{tan}^{- 1} ( \frac{λ}{{D}_{o}} )}^{2}$$

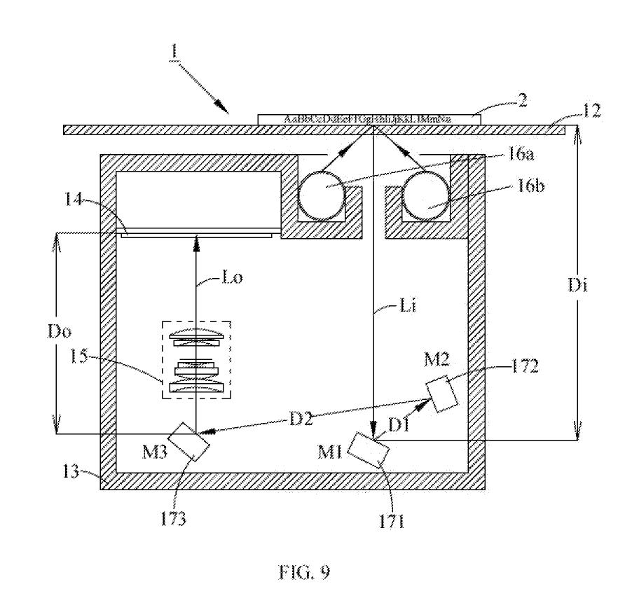

In a second preferred embodiment, a scanning module with three reflection mirrors is adopted. With reference to FIG. 9, a schematic view of a scanning module 1 using three reflection minors in accordance with a second preferred embodiment of the present invention is shown. The scanning module 1 comprises two xenon lamp light sources 16a, 16b, three reflection mirrors M1 (171), M2 (172), M3 (173), a pickup lens 15, an image sensor 14 and a frame 13.

The light source 16a, 16b emit lights that pass through a cover glass 12 and are projected onto the document 2 to be scanned to produce an image beam Lᵢ incident to the scanning module 1. The image beam Lᵢ is reflected by the reflection mirror M1, reflected light beam reflected by the reflection minor M2 and the reflection mirror M3, an image beam Lₒ is formed, and then the pickup lens 15 focuses the image beam Lₒ to form an image at the surface of image sensor 14. The frame 13 is provided for accommodating each component in the scanning module 1. The optical path is Obj→M1→M2→M3→Img, and the total optical path length (TTL) is Di+D₁+D₂+Do=184.01 mm. An included angle between the normal line of the reflecting surface of the reflection mirror M1 (171), M2 (172), M3 (173) and the +Z-axis is αᵢ, and the coordinates of the reflecting point of the reflection mirror M1 (171), M2 (172), M3 (173) is (M_{iX}, M_{iZ}) as shown in Table 2:

TABLE 2
Optical Parameters of the Second Preferred Embodiment

| Surface | αᵢ(°Deg.) | Di(mm) | (M_{iX}, M_{iZ}) |
|---|---|---|---|
| Obj | | 0 | (0, 0) |
| M1 | 153.15 | 69.54 | (0, 69.54) |
| M2 | 67.82 | 15.87 | (12.83, 60.19) |
| M3 | 139.53 | 52.63 | (−39.18, 68.11) |
| Img | | 45.97 | (−40.38, 22.15) |

Since the traveling directions of the image beam Lᵢ incident to the scanning module 1 and the image beam Lₒ incident to the pickup lens 15 are opposite to each other; and the optical path is in a U-shape, and the pickup lens 15 is aligned towards the −Z-axis direction, therefore the scattered light of the image beam Li can be reduced, and the scattered light of the image beam reflected from the reflection mirror M1, M2 and entering into the pickup lens 15 can be reduced to eliminate the ghost image phenomenon effectively.

On the X-Z plane, \vec{L}ₒ=(−1.2\vec{i}−49.55\vec{k}), and θ=2.88 (deg.) satisfy the condition of:

$$- 1 \leq \frac{{\vec{L}}_{o} \cdot \vec{k}}{\vert {\vec{L}}_{o} \vert} = - 0.998 \leq - 0.707$$

where an included angle θ is an included angle between the image beam Lₒ and an axial line parallel to the Z-axis, |\vec{L}ₒ| is the length of the image beam Lo, and \vec{k} is a unit vector in the +Z-axis direction.

The angles of the reflection mirror M1 (171), the reflection mirror M2 (172) and the reflection mirror M3(173) and

$${\sum }_{i = 1}^{3} {α}_{i} - \frac{π}{2} ( 3 + 1 ) = 0.00278 π$$

satisfy the condition of:

$$- \frac{π}{4} \leq {\sum }_{i = 1}^{3} {α}_{i} - \frac{π}{2} ( 3 + 1 ) = 0.00278 π \leq \frac{π}{4}$$

where αᵢ is an included angle between the normal line of a reflecting surface of the i^{th} reflection mirror in the optical path and the +Z-axis, and n is the total number of reflecting times along the optical path, and n=3 in this preferred embodiment.

The image sensor 14 used in this preferred embodiment is 1.58×35.02 mm, 2λ=35.05 mm, and tan

$${{tan}^{- 1} ( \frac{λ}{{D}_{o}} )}^{2} = 8.2716 ( deg . ) .$$

The included angle θ between the optical axis of the pickup lens 15 and the image sensor 14 and the axial line parallel to the Z-axis equals to 1.26° in this preferred embodiment and satisfies the condition of:

$$θ = 1.26 ° \leq {{tan}^{- 1} ( \frac{λ}{{D}_{o}} )}^{2}$$

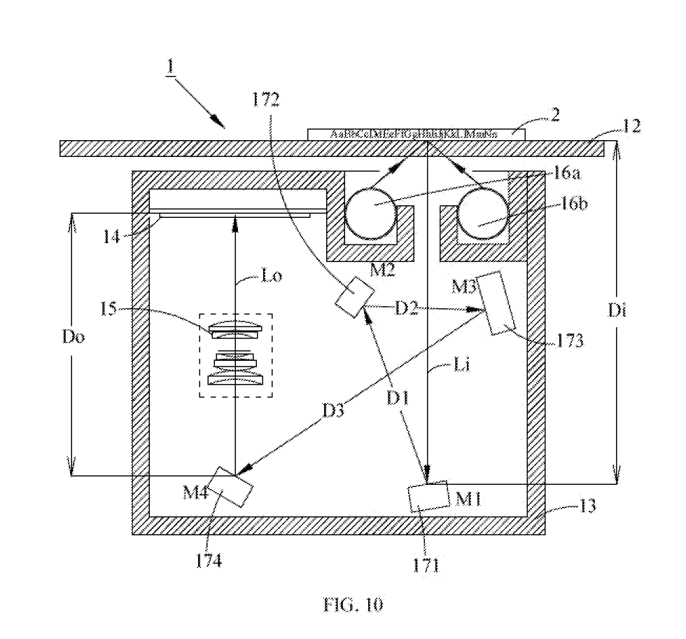

In a third preferred embodiment, a scanning module with four reflection mirrors is adopted. With reference to FIG. 10, a schematic view of a scanning module using four reflection mirrors in accordance with a third preferred embodiment of the present invention is shown. The scanning module 1 comprises two LED lamp light sources 16a, 16b, four reflection mirrors M1 (171), M2 (172), M3 (173), M4 (174), a pickup lens 15, an image sensor 14 and a frame 13.

The light source 16a, 16b emit lights that pass through a cover glass 12 and are projected onto the document 2 to be scanned to produce an image beam Lᵢ incident to the scanning module 1. The image beam Lᵢ is reflected by the reflection mirrors M1, M2, M3 and M4, an image beam Lₒ is formed, and then the pickup lens 15 focuses the image beam Lₒ to form an image at the surface of image sensor 14. The frame 13 is provided for accommodating each component in the scanning module 1. The optical path is Obj→M1→M2→M3→M4→Img, and the total optical path length (TTL) is Di+D₁+D₂+D₃+Do=248.60. An included angle between the normal line of the reflecting surface of the reflection mirror M1 (171), M2 (172), M3 (173), M4 (174) and the +Z-axis is αᵢ, and the coordinates of the reflecting point of the reflection mirror M1 (171), M2 (172), M3 (173), M4 (174) is (M_{iX}, M_{iZ}) as shown in Table 3:

TABLE 3
Optical Parameters of the Third Preferred Embodiment

| Surface | αᵢ (°Deg.) | Di(mm) | (M_{iX}, M_{iZ}) |
|---|---|---|---|
| Obj | | 0 | (0, 0) |
| M1 | 169.98 | 70.18 | (0, 70.18) |
| M2 | 52.26 | 38.60 | (−13.02, 33.87) |
| M3 | 74.16 | 24.91 | (11.93, 34.75) |
| M4 | 151.41 | 61.28 | (−39.18, 66.57) |
| Img | | 53.63 | (−40.38, 12.94) |

Since the traveling directions of the image beam Lᵢ incident to the scanning module 1 and the image beam Lₒ incident at the pickup lens 15 are opposite to each other; and the optical path is in a U-shape, and the pickup lens 15 is aligned towards the −Z-axis direction, therefore the scattered light of the image beam Lᵢ can be reduced, and the scattered light of the image beam reflected from the reflection mirror M1, M2, M3 and entering into the pickup lens 15 can be reduced to eliminate the ghost image phenomenon effectively.

On the plane X-Z, \vec{L}ₒ=(−1.2\vec{i}−55.63\vec{k}), and φ=4.678 (deg.) satisfy the condition of:

$$- 1 \leq \frac{{\overline{L}}_{o} \cdot \overline{k}}{\vert {\overline{L}}_{o} \vert} = - 0.966 \leq - 0.707$$

where an included angle φ is an included angle between the image beam Lₒ and an axial line parallel to the Z-axis, |\vec{L}ₒ| is the length of the image beam Lₒ, and \vec{k} is a unit vector in the +Z-axis direction.

The angles of the reflection mirror M1 (171), the reflection mirror M2 (172), the reflection mirror M3 (173) and the reflection mirror M4 (174) and

$${\sum }_{i = 1}^{4} {α}_{i} - \frac{π}{2} ( 4 + 1 ) = - 0.0122 π$$

satisfy the condition of:

$$- \frac{π}{4} \leq {\sum }_{i = 1}^{4} {α}_{i} - \frac{π}{2} ( 4 + 1 ) = - 0.0122 π \leq \frac{π}{4}$$

where αᵢ is an included angle between the normal line of a reflecting surface of the i^{th} reflection mirror in the optical path and the +Z-axis, and n is the total number of reflecting times along the optical path, and n=4 in this preferred embodiment.

The image sensor 14 used in this preferred embodiment is 1.58×35.02 mm, 2λ=35.05 mm, and tan

$${{tan}^{- 1} ( \frac{λ}{{D}_{o}} )}^{2} = 4.678 ( deg . ) .$$

The included angle θ between the optical axis of the pickup lens 15 and the image sensor 14 and the axial line parallel to the Z-axis equals to 1.56° in this preferred embodiment and satisfies the condition of:

$$θ = 1.56 ° \leq {{tan}^{- 1} ( \frac{λ}{{D}_{o}} )}^{2}$$

With reference to FIG. 11, a scanning module using five reflection mirrors in accordance with a fourth preferred embodiment of the present invention is shown. The scanning module 1 comprises two LED lamp light sources 16a, 16b, five reflection mirrors M1 (171), M2 (172), M3 (173), M4 (174), M5 (175), a pickup lens 15, a image sensor 14 and a frame 13.

The light source 16a, 16b emit lights that pass through a cover glass 12 and are projected onto the document 2 to be scanned to produce an image beam Lᵢ incident to the scanning module 1. The image beam Lᵢ is reflected by each reflection mirror, an image beam Lₒ is formed, and then the pickup lens 15 focuses the image beam Lₒ to form an image at the surface of image sensor 14. The frame 13 is provided for accommodating each component in the scanning module 1. The optical path is Obj→M1→M2→M3→M4→M3→M4→M3→M4→M2→M5→Img, and the total optical path length (TTL) is Di+D₁+D₂+D₃+D₄+D₅+D₆+D₇+D₈+Do=363.01. An included angle between the normal line of the reflecting surface of the reflection mirror M1 (171), M2 (172), M3 (173), M4 (174), M5 (175) and the +Z-axis is αᵢ, and the coordinates of the reflecting point of the reflection mirror M1 (171), M2 (172), M3 (173), M4 (174), M5 (175) is (M_{iX}, M_{iZ}) as shown in Table 4:

TABLE 4
Optical Parameters of the Fourth Preferred Embodiment

| Surface | αᵢ(°Deg.) | Di(mm) | (M_{iX}, M_{iZ}) |
|---|---|---|---|
| Obj | | 0 | (0, 0) |
| M1 | 149.51 | 69.54 | (0, 69.54) |
| M2 | 88.48 | 16.39 | (14.32, 61.46) |
| M3 | 90.23 | 31.91 | (−13.65, 46.10) |
| M4 | 81.53 | 28.12 | (11.87, 34.17) |
| M3 | 90.23 | 25.18 | (−13.17, 31.58) |
| M4 | 81.53 | 24.47 | (11.28, 30.65) |
| M3 | 90.23 | 25.77 | (−13.39, 38.17) |
| M2 | 88.48 | 29.55 | (14.25, 48.61) |
| M5 | 145.46 | 57.35 | (−39.18, 69.47) |
| Img | | 54.74 | (−40.38, 12.10) |

Since the traveling directions of the image beam Lᵢ incident to the scanning module 1 and the image beam Lₒ incident at the pickup lens 15 are opposite to each other; and the optical path is in a U-shape, and the pickup lens 15 is aligned towards the −Z-axis direction, therefore the scattered light of the image beam Lᵢ can be reduced, and the scattered light of the image beam reflected from each reflection mirror and entering into the pick-up lens 15 can be reduced to eliminate the ghost image phenomenon effectively.

On the plane X-Z, \vec{L}ₒ=(−1.2\vec{i}−57.37\vec{k}) and φ=1.256 (deg.) satisfy the condition of:

$$- 1 \leq \frac{{\vec{L}}_{o} \cdot \vec{k}}{\vert {\vec{L}}_{o} \vert} = - 0.9997 \leq - 0.707$$

where φ is an included angle between the image beam Lₒ and an axial line parallel to the Z-axis, |\vec{L}ₒ| is the length of the image beam Lo, and \vec{k} is a unit vector in the +Z-axis direction.

The angles of the reflection mirror M1 (171), the reflection mirror M2 (172), the reflection mirror M3 (173), the reflection mirror M4 (174) and the reflection minor M5 (175) and

$${\sum }_{i = 1}^{9} {α}_{i} - \frac{π}{2} ( 9 + 1 ) = 0.0316 π$$

satisfy the condition of:

$$- \frac{π}{4} \leq {\sum }_{i = 1}^{9} {α}_{i} - \frac{π}{2} ( 9 + 1 ) = 0.0316 π \leq \frac{π}{4}$$

where αᵢ is an included angle between the normal line of a reflecting surface of the i^{th} reflection mirror in the optical path and the +Z-axis, and n is the total number of reflecting times along the optical path, and n=9 in this preferred embodiment.

The image sensor 14 used in this preferred embodiment is 1.58×35.02 mm, 2λ=35.05 mm, and tan

$${{tan}^{- 1} ( \frac{λ}{{D}_{o}} )}^{2} = 4.678 ( deg . ) .$$

The included angle θ between the optical axis of the pickup lens 15 and the image sensor 14 and an axial line parallel to the Z-axis equals to 1.13° in this preferred embodiment and satisfies the condition of:

$$θ = 1.13 ° \leq {{tan}^{- 1} ( \frac{λ}{{D}_{o}} )}^{2}$$

In summation of the description above, the effect of the scanning module is achieved by the U-shape optical path image scanning method in accordance with the present invention, less reflection mirrors are used for performing the multiple reflections to increase the length of the optical path and the depth of field. In addition, the optical path is in a U-shape optical path and capable of reducing or eliminate the scattered lights produced by several times of the reflection, so as to stop the ghost image phenomenon.

The scanning module of the invention can achieve another effect of adjusting the optical axis of the pickup lens and image sensor easily and coincide with the optical axis with the image beam L2 during manufacture or assembly, so as to reduce the assembly difficulty and enhance the mass production rate.

The scanning module of the invention is applicable for one light source or two (or more) light sources, and 2, 3, 4, 5 (or more) reflection mirrors to produce different depths of field. In addition, the position of the pickup lens can be adjusted to fit a pickup lens of a different focal length, so as to provide a broader scope of application.

While the invention has been described by means of specific embodiments, numerous modifications and variations could be made thereto by those skilled in the art without departing from the scope and spirit of the invention set forth in the claims.

What is claimed is:

1. A U-shape optical path image scanning method for a scanning module, the scanning module having at least one light source, a plurality of reflection mirrors, a pickup lens and an image sensor, and the method comprising the steps of:
emitting a light by said light source to be incident to a document to be scanned such that the light reflected from the document to be scanned forms an image beam Lᵢ, wherein said image beam Lᵢ injected into the scanning module leads in a +Z-axis direction;
disposing a plurality of reflection mirrors such that said plurality of reflection mirrors reflect the image beam Lᵢ to form an image beam Lₒ incident to said pickup lens, wherein the image beam Lᵢ and image beam Lₒ are in opposite directions and the optical path is U-shaped;
adjusting an included angle φ between the image beam Lₒ and the image beam Lᵢ on a X-Z plane to satisfy the condition of:
$$- 1 \leq cos ( π - φ ) = \frac{{\vec{L}}_{o} \cdot \vec{k}}{\vert {\vec{L}}_{o} \vert} \leq - 0.707 ;$$
where φ is an included angle between the image beam Lₒ and an axial line parallel to the Z-axis, and \vec{k} is a unit vector in the +Z-axis direction, and |\vec{L}ₒ| is the length of the image beam Lo; and
calibrating optical axis of said pickup lens and said image sensor such that the optical axis are coincide with the image beam Lₒ.

2. The U-shape optical path image scanning method at set forth in claim 1, wherein the included angle θ formed by the adjusted optical axis of said pickup lens and said image sensor and the axial line parallel to said image beam Lᵢ, satisfies the condition of:
$$θ \leq {{tan}^{- 1} ( \frac{λ}{{D}_{o}} )}^{2} ;$$
where 2λ is a diagonal length of an effective sensing range of the image sensor, and Do is the distance from the last reflecting point to the surface of the image sensor along the optical axis.

3. A scanning module, comprising: at least one light source, a plurality of reflection mirrors, a pickup lens, and an image sensor and a frame;
wherein,
said light source emits a light incident to a document to be scanned to produce an image beam Lᵢ reflected from the document to be scanned to the scanning module;
said plurality of reflection mirrors are provided for reflecting the image beam Lᵢ to form an image beam Lₒ incident to the pickup lens, where the image beam Lᵢ and image beam Lₒ are in opposite directions and the optical path is U-shaped on the X-Z plane;
said pickup lens are used for focusing the incident image beam Lₒ on the surface of said image sensor,
said frame is provided for containing the light source, the plurality of reflection mirrors, the pickup lens and the image sensor;
the optical path satisfies the condition of:
$$- 1 \leq cos ( π - φ ) = \frac{{\vec{L}}_{o} \cdot \vec{k}}{\vert {\vec{L}}_{o} \vert} \leq - 0.707 ;$$
where φ is an included angle between the image beam Lₒ and an axial line parallel to the Z-axis, and \vec{k} is a unit vector in the +Z-axis direction, and |\vec{L}ₒ| is the length of the image beam Lₒ.

4. The scanning module at set forth in claim 3, wherein the angles between the plurality of reflection mirrors satisfy the condition of:
$$- \frac{π}{4} \leq {\sum }_{i = 1}^{n} {α}_{i} - \frac{π}{2} ( n + 1 ) \leq \frac{π}{4} ;$$
where αᵢ is an included angle formed by the normal line of a reflecting surface of the i^{th} one of the plurality of reflection mirrors and the +Z-axis along the optical path, and n is the total number of reflecting times along the optical path.

5. The scanning module at set forth in claim 3, wherein the included angles θ formed by the adjusted optical axis of said pickup lens and said image sensor and the axial line parallel to said image beam Lᵢ, satisfy the condition of:
$$θ \leq {{tan}^{- 1} ( \frac{λ}{{D}_{o}} )}^{2} ;$$
where 2λ is a diagonal length of an effective sensing range of the image sensor, and Do is the distance from the last reflecting point to the surface of image sensor along the optical axis.

6. The scanning module at set forth in claim 3, wherein the light source is one selected from the collection of a cold cathode fluorescent lamp, a light emitting diode (LED) lamp and a xenon lamp.

7. The scanning module at set forth in claim 3, wherein the reflection minors come with a quantity from two to six.
